(19) United States
(12) Patent Application Publication
(10) Pub. No.: US 2019/0168175 A1
(43) Pub. Date: Jun. 6, 2019

(54) Solids-Producing Siphoning Exchanger

(71) Applicants: Larry Baxter, Orem, UT (US); Aaron Sayre, Spanish Fork, UT (US); Seth Babcock, Murray, UT (US); Nathan Davis, Bountiful, UT (US)

(72) Inventors: Larry Baxter, Orem, UT (US); Aaron Sayre, Spanish Fork, UT (US); Seth Babcock, Murray, UT (US); Nathan Davis, Bountiful, UT (US)

(21) Appl. No.: 15/833,279

(22) Filed: Dec. 6, 2017

(51) Int. Cl. B01F 5/04; B01D 7/00; B01D 53/00; B01F 3/04; B01D 25/12; F25J 3/08

(52) U.S. Cl. CPC B01F 5/043; B01D 7/00; B01D 53/002; B01F 3/0446; F25J 2205/20; F25J 3/08; F25J 2205/10; F25J 2205/84; B01D 25/12

(57) ABSTRACT

Devices, systems, and methods for siphoning heat exchange or reaction for solids production are disclosed. Passing a contact fluid through a siphoning device, wherein the siphoning device is made of a contact fluid inlet, a carrier fluid inlet, and an outlet, and wherein the contact fluid passes through the contact fluid inlet, inducing a siphon in the carrier fluid inlet. This siphon then siphons a carrier fluid through the carrier fluid inlet and into the contact fluid. The carrier fluid is, in part, made of a first component. The carrier fluid and the contact fluid mix. This mixing produces a product solid, wherein the product solid is produced from the first component by desublimation, condensation, solidification, crystallization, precipitation, reaction with the contact fluid, or a combination thereof of at least a portion of the first component. The product solid passes through the outlet.

### GOVERNMENT INTEREST STATEMENT

This invention was made with government support under DE-FE0028697 awarded by the Department of Energy. The government has certain rights in the invention.

### FIELD OF THE INVENTION

The devices and processes described herein relate generally to siphoning. More particularly, the devices and processes described herein relate to devices, systems, and methods for using siphoning for direct contact heat exchange.

### BACKGROUND

Separations of components out of fluids is a fundamental part of many industries. Gas-vapor, gas-liquid, and other fluid-fluid extractions can be taxing as they often require large volumes and complex mechanisms to maximize contact between fluids, maximizing fluid exchange rates. Devices, systems, and methods for extracting components from fluids without these difficulties would be beneficial.

### SUMMARY

Devices, systems, and methods for siphoning heat exchange or reaction for solids production are disclosed. Passing a contact fluid through a siphoning device, wherein the siphoning device is made of a contact fluid inlet, a carrier fluid inlet, and an outlet, and wherein the contact fluid passes through the contact fluid inlet, inducing a siphon in the carrier fluid inlet. This siphon then siphons a carrier fluid through the carrier fluid inlet and into the contact fluid. The carrier fluid is, in part, made of a first component. The carrier fluid and the contact fluid mix. This mixing produces a product solid, wherein the product solid is produced from the first component by desublimation, condensation, solidification, crystallization, precipitation, reaction with the contact fluid, or a combination thereof of at least a portion of the first component. The product solid passes through the outlet.

The process may produce a warm contact fluid and a component-depleted carrier fluid, wherein the warm contact fluid is produced by the carrier fluid transferring heat to the contact fluid, and wherein the component-depleted carrier fluid is produced when the first component is removed, at least in part, from the carrier fluid.

The outlet may be a converging/diverging nozzle. The converging-diverging nozzle may have a variable-diameter throat.

The outlet may split into a gas outlet and a liquid outlet. The warm contact liquid and the product solid may pass out the liquid outlet and the product-depleted carrier gas may pass out the gas outlet.

The product solid, the warm contact liquid, and the product-depleted carrier gas may be channeled into a liquid-gas separator which separates the product-depleted carrier gas from the product solid and the warm contact liquid. The product solid and the warm contact liquid may then pass through a solid-liquid separator which separates the product solid from the warm contact liquid. The solid-liquid separator may be a filtering screw press. The liquid-gas separator may include vortex chamber walls. The vortex chamber walls may be made of mesh, membranes, or a combination thereof.

The outlet may be a diverging/converging nozzle.

The eductor may have a plurality of siphon ports.

The eductor may be made of diamond, metal, plastic, ceramic, or a combination thereof.

The process may include recycling a portion of the product solid to the contact fluid inlet.

The contact fluid may include water, hydrocarbons, liquid ammonia, liquid carbon dioxide, cryogenic liquids, high-temperature liquids, or a combination thereof. The hydrocarbons may include 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methyl cyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or a combination thereof.

The carrier gas may include flue gas, syngas, producer gas, natural gas, steam reforming gas, hydrocarbons, light gases, refinery off-gases, organic solvents, steam, ammonia, or a combination thereof.

The siphon nozzle may include an aerator.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a cutaway side view of an eductor.

FIG. 2 shows a cutaway side view of an eductor attached to a solid-liquid separator.

FIG. 3 shows an isometric side-back elevation view of an eductor.

FIG. 4 shows a method for removing a vapor from a gas.

FIG. 5 shows a method for separating the product fluids from FIG. 4.

FIG. 6 shows a process flow diagram for removing a vapor from a gas.

### DETAILED DESCRIPTION

It will be readily understood that the components of the described devices, systems, and methods, as generally described and illustrated in the Figures herein, could be arranged and designed in a wide variety of different configurations. Thus, the following more detailed description of the embodiments of the described devices, systems, and methods, as represented in the Figures, is not intended to limit the scope of the described devices, systems, and methods, as claimed, but is merely representative of certain examples of presently contemplated embodiments in accordance with the described devices, systems, and methods.

Removing components from a carrier fluid can be challenging. For example, when the gas phase component desublimates into a solid, separations switch from only a gas-liquid separation to include solid-liquid separations. In standard heat exchangers, this desublimation can cause fouling which leads to losses in efficiency. Devices, systems, and methods disclosed herein address these issues. Eductors can be used to produce solids from the components of the carrier fluid, either by direct-contact heat and material exchange, by reaction, or a combination thereof. Accordingly, desublimation, condensation, freezing, deposition, precipitation, or reaction of products can occur in the contact fluid, avoiding solid products collecting on equipment surfaces. Eductors are also able to use a liquid phase contact fluid to siphon a gas phase carrier fluid. This is advantageous since liquid pumps are more efficient than gas compressors. This lowers operational expenses for component separations versus traditional systems.

In this application, the term “eductor” is used to represent any eductors, ejectors, jet pumps, or other siphoning devices. Siphoning devices are any device that uses the flow of a first fluid to induce a siphon effect that draws a second fluid into the first fluid. Further, the term “fluid” is not limited to pure gases and pure liquids, nor is the term “liquid” limited to only pure liquids. Fluids can be any gas, liquid, or solid that flows. Slurries, where a liquid has entrained a solid, colloidal suspensions, where a liquid has suspended a solid, and gas streams that have entrained solids are all considered fluids, and all but the last is considered a liquid. The term “siphon port” refers to the inlet in which the carrier fluid enters the siphoning device. The terms, “carrier fluid inlet,” “carrier gas inlet,” and “carrier liquid inlet” are also siphon ports.

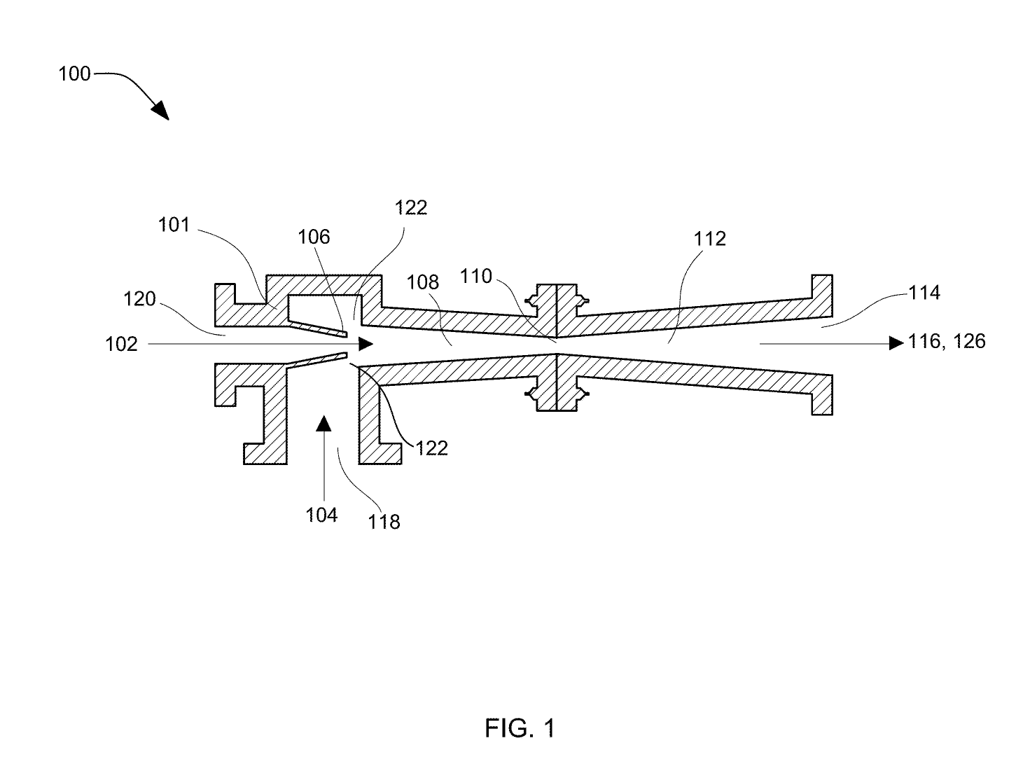

Referring now to the Figures, FIG. 1 shows a cutaway side view 100 of an eductor 101 that may be used in the described devices, systems, and methods. The eductor 101 consists of a contact fluid inlet 120, a contact fluid nozzle 106, a mixing chamber 122, a carrier fluid inlet 118, a converging nozzle 108, throat 110, diverging nozzle 112, and outlet 114. In this example, contact fluid 102 may be isopentane and carrier fluid 104 may be combustion flue gas. The isopentane 102 is pumped through inlet 120 and passes through nozzle 106 into mixing chamber 122. As the isopentane 102 flows through mixing chamber 122, it creates a siphon, pulling the combustion flue gas 104 in through carrier fluid inlet 118 into mixing chamber 122. In mixing chamber 122, the combustion flue gas 104 comes into contact with the isopentane 102 where it is mixed and entrained into the isopentane 102, resulting in at least a portion of the carbon dioxide in the combustion flue gas desublimating, producing a carbon dioxide slurry 116 and a carbon dioxide-depleted flue gas 126. The carbon dioxide slurry 116 and depleted flue gas 126 pass into converging nozzle 108, through throat 110, through diverging nozzle 112, and out outlet 114. The converging and diverging nozzles 108 and 112 are used because the carbon dioxide slurry 116 and depleted flue gas 126 are compressible. The entrained depleted flue gas 126 makes the isopentane-based slurry compressible even at low Mach numbers.

In some embodiments, nozzle 106 may end with an aerator to allow better mixing of contact fluid 102 and carrier fluid 104. In some embodiments, throat 110 may be a variable-diameter throat.

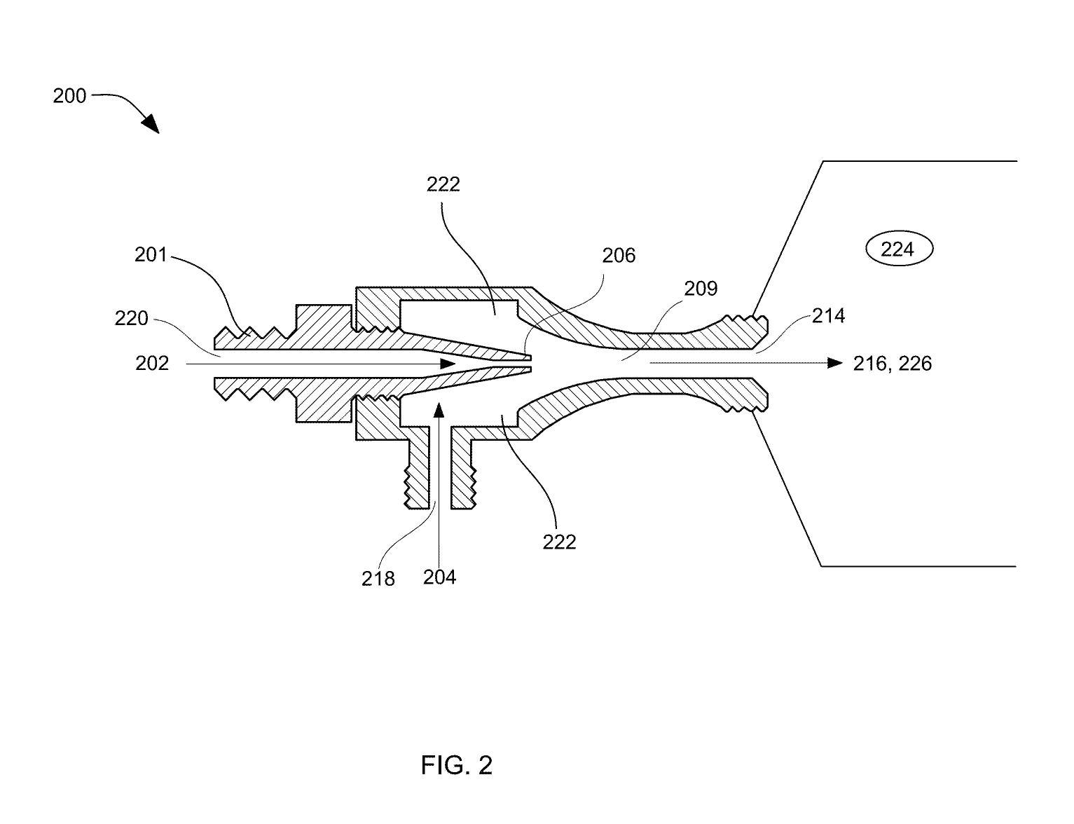

Referring now to FIG. 2, FIG. 2 shows a cutaway side view 200 of an eductor 201 that may be used in the described devices, systems, and methods. The eductor 201 consists of a contact fluid inlet 220, a contact fluid nozzle 206, a mixing chamber 222, a carrier fluid inlet 218, a nozzle 209, and an outlet 214. In this example, contact fluid 202 is a liquid and carrier fluid 204 is a gas. Contact fluid 202 is pumped through inlet 220 and passes through nozzle 206 into mixing chamber 222. As contact fluid 202 flows through mixing chamber 222 it creates a siphon, pulling carrier fluid 204 in through carrier fluid inlet 218 into mixing chamber 222. Carrier fluid 204 includes a vapor component. In mixing chamber 222, carrier fluid 204 comes into contact with contact fluid 202 where it is mixed and entrained into the contact fluid 202, resulting in at least a portion of the vapor component in the carrier fluid 204 desublimating, condensing, freezing, depositing, precipitating, reacting, or a combination thereof to become a product solid, thereby producing a slurry 216 and a vapor component-depleted carrier fluid 226. The slurry 216 and depleted carrier fluid 226 passes through the nozzle 209, the outlet 214, and into a gas-liquid separator 224. The vapor component-depleted carrier gas 226 is separated from the slurry 216 as it passes through the gas-liquid separator 224.

In some embodiments, after the slurry 216 leaves the gas-liquid separator 224, a portion of the slurry is recycled back into the contact liquid 202 to act as nucleation sites to assist in the formation of the product solid.

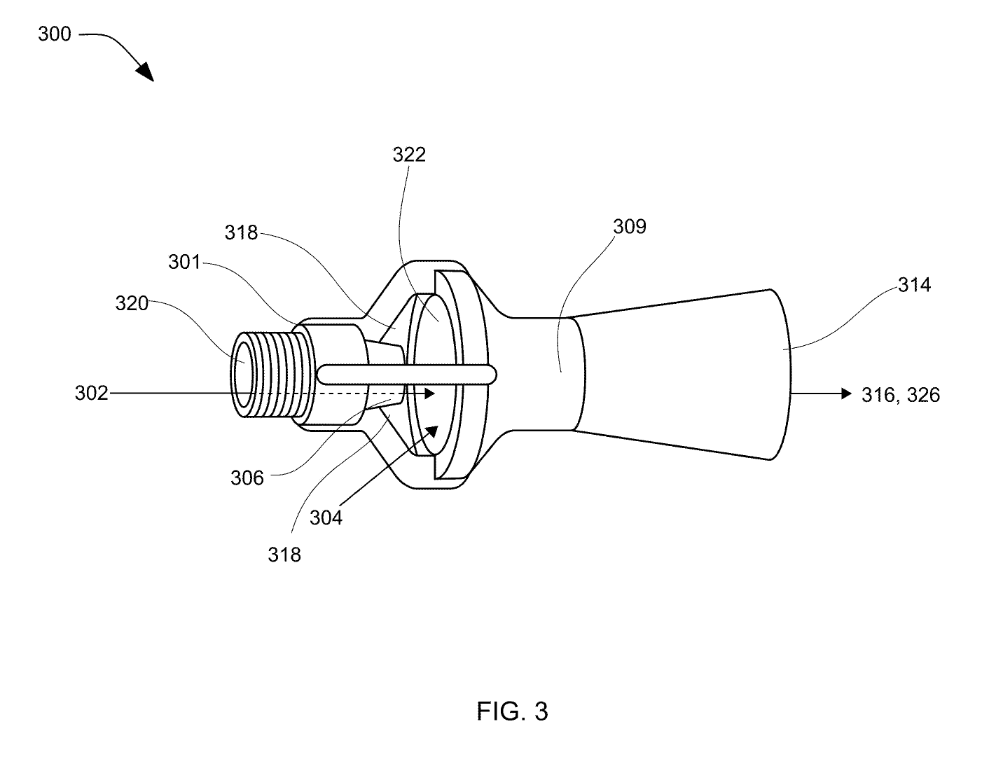

Referring now to FIG. 3, FIG. 3 shows an isometric side-back elevation view 300 of an eductor 301 that may be used in the described devices, systems, and methods. The eductor 301 consists of a contact fluid inlet 320, a contact fluid nozzle 306, a mixing chamber 322, a plurality of carrier fluid inlet 318, a nozzle 309, and an outlet 314. In this example, contact fluid 302 is a liquid and carrier fluid 304 is a gas. Contact fluid 302 is pumped through inlet 320 and passes through nozzle 306 into mixing chamber 322. Carrier fluid 304 includes a vapor component. As contact fluid 302 flows through mixing chamber 322 it creates a siphon, pulling carrier fluid 304 in through the plurality of carrier fluid inlets 318 into mixing chamber 322. In mixing chamber 322, carrier fluid 304 comes into contact with contact fluid 302 where it is mixed and entrained into the contact fluid 302, resulting in at least a portion of the carbon dioxide in the combustion flue gas desublimating, condensing, freezing, depositing, precipitating, reacting, or a combination thereof to become a product solid, thereby producing a slurry 316 and vapor component-depleted carrier fluid 226. The slurry 316 passes through a nozzle 309, an outlet 314.

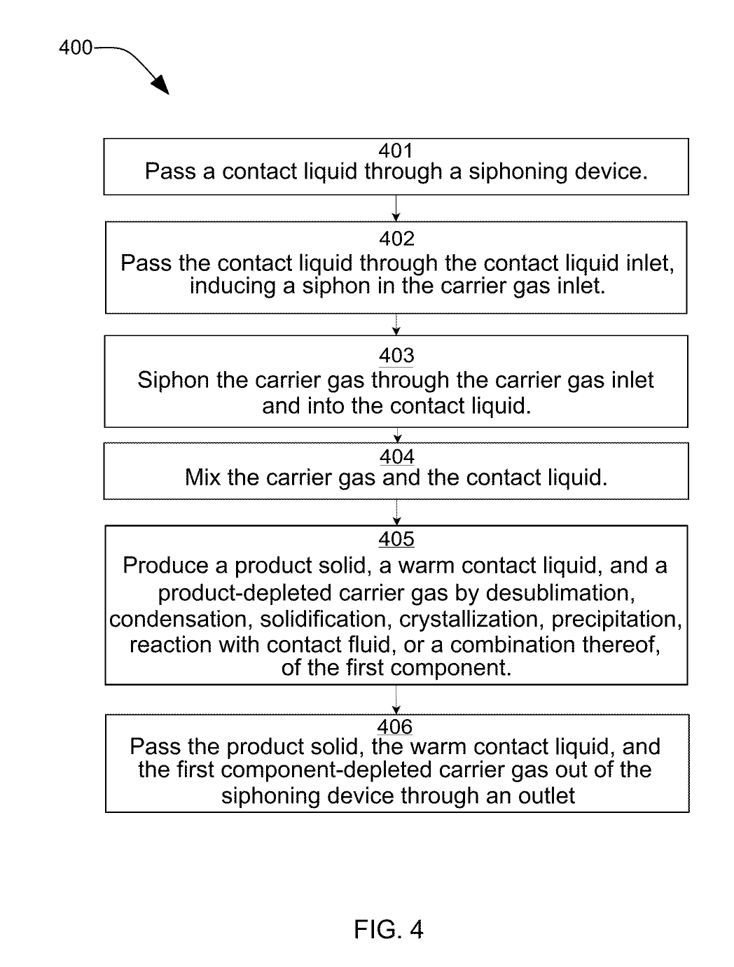

Referring now to FIG. 4, a method 400 for removing a vapor from a carrier gas is disclosed that may be used in the described devices, systems, and methods. At 401, a contact liquid is passed through a siphoning device. The siphoning device includes a contact liquid inlet, a carrier gas inlet, and an outlet. At 402, the contact liquid passes through the contact liquid inlet, inducing a siphon in carrier gas inlet. At 403, the carrier gas is siphoned through the carrier gas inlet and into the contact liquid. The carrier gas includes a product vapor. At 404, the carrier gas and the contact liquid are mixed. At 405, the product vapor is desublimated, condensed, solidified, crystallized, precipitated, reacted with the contact fluid, or a combination thereof, producing a product solid, a warm contact liquid, and a product-depleted carrier gas. At 406, the product solid, the warm contact liquid, and the product-depleted carrier gas are passed out of the siphoning device through an outlet.

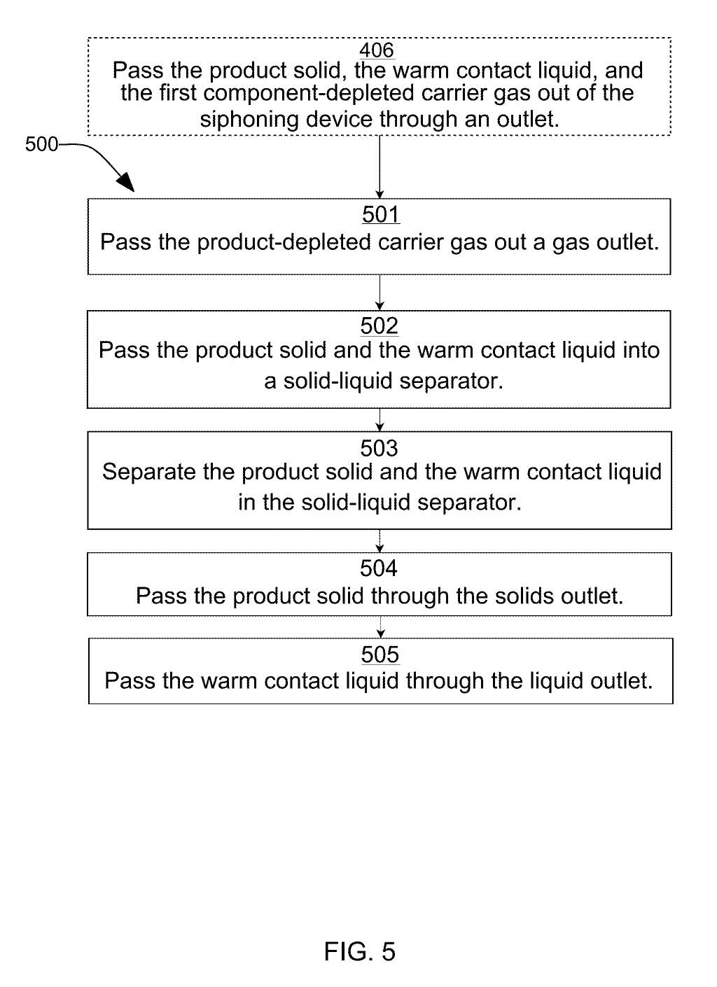

Referring now to FIG. 5, a method 500 for separating the product fluids of method 400 is disclosed. At 406, the product solid and the warm contact liquid passed out a liquid outlet. At 501, the product-depleted carrier gas passes out a gas outlet. At 502, the product solid and the warm contact liquid are passed into a solid-liquid separator. At 503, the product solid and the warm contact liquid are separated in the solid-liquid separator. At 504, the product solid passes out a solids outlet. At 505, the warm carrier liquid passes out a liquid outlet.

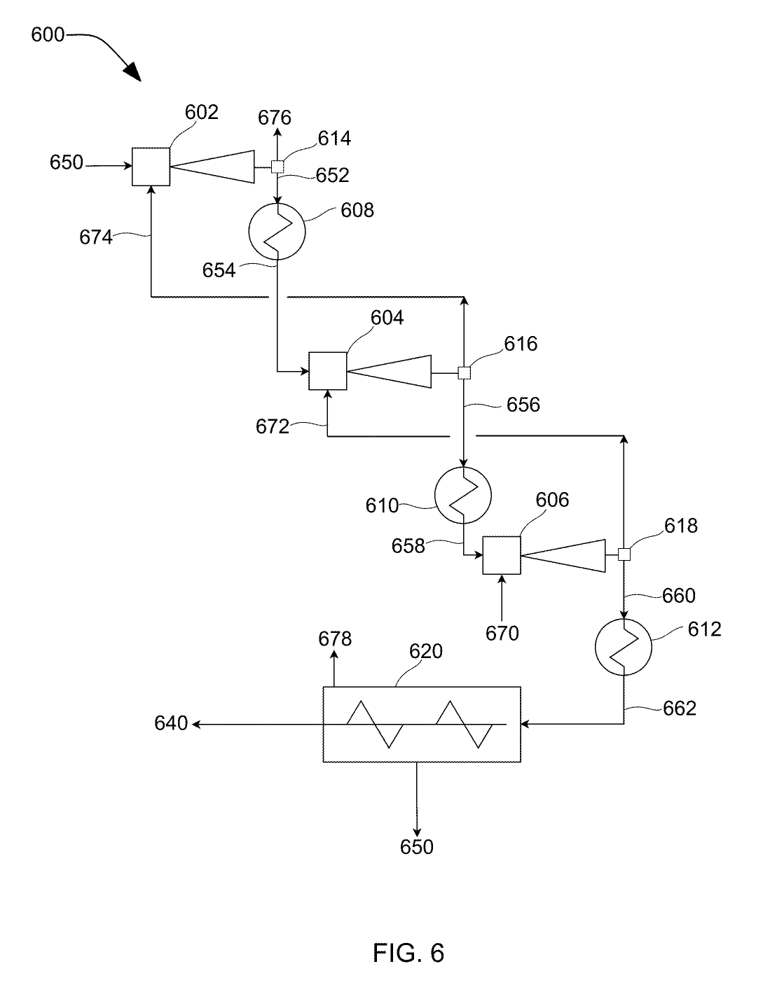

Referring now to FIG. 6, FIG. 6 shows a process flow diagram 600 for removing a vapor from a carrier gas that may be used in the described devices, systems, and methods. A first-stage contact fluid 650 is passed into a first eductor 602, siphoning first-stage carrier gas 674 into first eductor 602. First-stage carrier gas 674 includes a vapor component. The fluids mix in first eductor 602 and produce a product solid from at least a portion of the vapor component, a warm first-stage contact fluid, and a stripped carrier gas 676. Eductor 602 ends at a gas-liquid separator 614 which separates the stripped carrier gas 676 from a first-stage product slurry 652. The first-stage product slurry 652 consists of warm first-stage contact fluid and the product solid. The first-stage product slurry 652 is cooled as it passes through heat exchanger 608, forming a second-stage contact slurry 654. The second-stage contact slurry 654 is then fed into the second eductor 604 as the second-stage contact fluid. The second-stage contact slurry 654 creates the siphon in the second eductor 604, siphoning second-stage carrier gas 672 into second eductor 604. Second-stage carrier gas 672 includes the vapor component in a larger quantity than the first-stage carrier gas 674. Second-stage contact slurry 654 mixes with the second-stage carrier gas 672, producing more product solid, a warm second-stage contact slurry, and the first-stage carrier gas 674. Eductor 604 ends at a gas-liquid separator 616 which separates the first-stage carrier gas 674 from a second-stage product slurry 656. The second-stage product slurry 656 consists of the warm second-stage contact slurry and the additional product solid. The second-stage contact slurry 656 is cooled as it passes through heat exchanger 610, forming a third-stage contact slurry 658. The third-stage contact slurry is then fed into the third eductor 606 as the contact fluid. The third-stage contact slurry 658 creates the siphon in the third eductor 606, siphoning the carrier gas 670 into third eductor 606. The carrier gas 670 includes the vapor component in a larger quantity than the second-stage carrier gas 672. The third-stage contact slurry 658 mixes with the carrier gas 670, producing more product solid, a warm third-stage product slurry, and the second-stage carrier gas 672. Eductor 606 ends at a gas-liquid separator 618 which separates the third-stage carrier gas 672 from a third-stage product slurry 660. The third-stage product slurry 660 consists of the warm third-stage contact slurry and the additional product solid. The third-stage product slurry 660 is cooled as it passes through heat exchanger 612, forming a product slurry 662. The product slurry 662 is then passed through a solid-liquid separation unit 620. The separation unit 620, in this example, represented as a filtering screw press, filters the first-stage contact fluid 650 out of the product solids 640. Any remaining or evolved gases 678 are also separated from the product solids 640 in this unit.

The use of heat exchangers 608, 610, and 612 after each eductor 602, 604, and 606, respectively, is done for efficiency gains. Cooling efficiency has an inverse relationship to the size of the temperature change. By using heat exchangers 608, 610, and 612 after eductors 602, 604, and 606 the fluid being cooled will need to be cooled less, and thus more efficiently, than if there was just one heat exchanger before the eductor 602 that cooled the fluid to a low enough temperature for the fluid to be useful through all three eductors 602, 604, and 606. The efficiency gains decrease the cost of operation, which should more than cover the cost of the extra heat exchangers.

In some embodiments, heat exchangers 608, 610, and 612 are direct-contact gas-liquid heat exchangers.

In some embodiments, the eductors may be made of diamond, metal, plastic, ceramic, or a combination thereof.

Combustion flue gas consists of the exhaust gas from a fireplace, oven, furnace, boiler, steam generator, or other combustor. The combustion fuel sources include coal, hydrocarbons, and biomass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

1. A method for removing a vapor from a gas comprising:
passing a contact fluid through a siphoning device, wherein the siphoning device comprises a contact fluid inlet, a carrier fluid inlet, and an outlet, and wherein the contact fluid passes through the contact fluid inlet, inducing a siphon in the carrier fluid inlet;
siphoning a carrier fluid through the carrier fluid inlet and into the contact fluid, the carrier fluid comprising a first component;
mixing the carrier fluid and the contact fluid, wherein mixing produces a product solid, wherein the product solid is produced from the first component by desublimation, condensation, solidification, crystallization, precipitation, reaction with the contact fluid, or a combination thereof of at least a portion of the first component; and
passing the product solid through the outlet.

2. The process of claim 1, wherein mixing further produces a warm contact fluid and a component-depleted carrier fluid, wherein the warm contact fluid is produced by the carrier fluid transferring heat to the contact fluid, and wherein the component-depleted carrier fluid is produced when at least a portion of the first component is removed from the carrier fluid.

3. The process of claim 2, further comprising passing the product solid, the warm contact fluid, and the component-depleted carrier fluid through a converging/diverging nozzle.

4. The process of claim 3, wherein the converging-diverging nozzle comprises a variable-diameter throat.

5. The process of claim 1, further comprising passing the warm contact fluid and the product solid out a liquid outlet and passing the component-depleted carrier fluid out a gas outlet, wherein the outlet splits into the gas outlet and the liquid outlet.

6. The process of claim 5, further comprising passing the product solid and the warm contact fluid through a solid-liquid separator and separating the product solid from the warm contact fluid.

7. The process of claim 5, wherein the solid-liquid separator comprises a filtering screw press.

8. The process of claim 5, wherein the outlet comprises vortex chamber walls, the vortex chamber walls comprising mesh, membranes, or a combination thereof.

9. The process of claim 1, further comprising passing the product solid, the warm contact fluid, and the component-depleted carrier fluid through a diverging/converging nozzle.

10. The process of claim 1, wherein the siphoning device comprises a plurality of carrier fluid inlets.

11. The process of claim 1, further comprising recycling a portion of the product solid to the contact fluid inlet.

12. The process of claim 1, wherein the contact fluid comprises water, hydrocarbons, liquid ammonia, liquid carbon dioxide, cryogenic liquids, high-temperature liquids, or a combination thereof.

13. The process of claim 1, wherein the hydrocarbons comprise 1,1,3-trimethylcyclopentane, 1,4-pentadiene, 1,5-hexadiene, 1-butene, 1-methyl-1-ethylcyclopentane, 1-pentene, 2,3,3,3-tetrafluoropropene, 2,3-dimethyl-1-butene, 2-chloro-1,1,1,2-tetrafluoroethane, 2-methylpentane, 3-methyl-1,4-pentadiene, 3-methyl-1-butene, 3-methyl-1-pentene, 3-methylpentane, 4-methyl-1-hexene, 4-methyl-1-pentene, 4-methylcyclopentene, 4-methyl-trans-2-pentene, bromochlorodifluoromethane, bromodifluoromethane, bromotrifluoroethylene, chlorotrifluoroethylene, cis 2-hexene, cis-1,3-pentadiene, cis-2-hexene, cis-2-pentene, dichlorodifluoromethane, difluoromethyl ether, trifluoromethyl ether, dimethyl ether, ethyl fluoride, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, or a combination thereof.

14. The process of claim 1, wherein the carrier fluid comprises flue gas, syngas, producer gas, natural gas, steam reforming gas, hydrocarbons, light gases, refinery off-gases, organic solvents, steam, ammonia, or a combination thereof.

15. A siphoning device comprising:
a chamber;
a contact fluid nozzle, wherein the contact fluid nozzle directs a contact fluid into the chamber and through an outlet;
a carrier fluid inlet, wherein the carrier fluid inlet draws a carrier fluid into the chamber due to a siphoning effect from the contact fluid passing through the chamber, wherein the carrier fluid comprises a first component, wherein the carrier fluid and the contact fluid mix in the chamber, and wherein at least a portion of the first component desublimates, condenses, solidifies, crystallizes, precipitates, reacts, or a combination thereof in the contact liquid, producing a product solid; and
the outlet, wherein the outlet passes the product solid out of the siphoning device.

16. The siphoning device of claim 15, wherein the outlet is a converging/diverging nozzle.

17. The siphoning device of claim 15, further comprising a liquid-gas separator attached to the outlet.

18. The siphoning device of claim 17, wherein the liquid-gas separator comprises vortex chamber walls, the vortex chamber walls comprising mesh, membranes, or a combination thereof.

19. The siphoning device of claim 18, further comprising a solid-liquid separator.

20. The siphoning device of claim 19, wherein the solid-liquid separator comprises a filtering screw press.
